(19) United States
(12) Patent Application Publication
(10) Pub. No.: US 2025/0128137 A1
(43) Pub. Date: Apr. 24, 2025

(54) METHOD FOR PROVIDING AUTONOMOUS PUTTING TRAINING SYSTEM

(71) Applicant: VROTEIN INC., Suwon-si Gyeonggi-do (KR)

(72) Inventors: Chan Ki KIM, Gwangju-si Gyeonggi-do (KR); Sung Hyun MUN, Gwangmyeong-si Gyeonggi-do (KR)

(73) Assignee: VROTEIN INC., Suwon-si Gyeonggi-do (KR)

(21) Appl. No.: 18/505,317

(22) Filed: Nov. 9, 2023

(30) Foreign Application Priority Data
Oct. 19, 2023 (KR) 10-2023-0140266

(51) Int. Cl. A63B 69/36; A63B 71/06

(52) U.S. Cl. CPC A63B 69/3682; A63B 71/0622; A63B 2214/00; A63B 2225/50

(57) ABSTRACT

The present disclosure relates to a method for providing an autonomous putting training system formed by a main server and relates to a technology of providing an autonomous training creation UI to a user terminal, receiving a type of a training course of autonomous training to be performed and the number of steps in the training course from the user terminal by a main server, generating autonomous training, providing a training progress UI when training is performed for the generated autonomous training, controlling a projector to sequentially project an image of the hole cup, a start position of the ball, and line information stored for each step on a putting field, and providing statistics information analyzing a trajectory of the ball, a success rate, and a training time for each step to the user terminal through a statistics UI when the autonomous training is completed.

### CROSS-REFERENCE TO RELATED APPLICATION

This application is based on and claims priority under 35 U.S.C. § 119 to Korean Patent Application No. 10-2023-0140266, filed on Oct. 19, 2023, in the Korean Intellectual Property Office, the disclosure of which is incorporated by reference herein in its entirety.

### BACKGROUND

### 1. Field

The present disclosure relates to an autonomous putting training system and a method therefor, more specifically, the present disclosure relates to a technology that provides a plurality of training functions of providing autonomous training content, analyzing user's putting made on a putting field during provided training, providing the most ideal putting path for a ball of putting to reach a hole cup, and putting the ball in such an ideal putting path.

### 2. Description of the Related Art

Recently, as a golf game playing in a screen golf range, an indoor golf practice range, or the like has become popular among the public, related entertainment service businesses are increasing.

Particularly, with regard to putting, which is part of the golf game, the indoor golf practice range, rather than the existing outdoor practice range, is becoming popular. In the indoor golf practice range, a system for providing training content related to putting and swing of the golf.

However, such a system has a problem in that the sense of reality is lower than that of training conducted in an actual golf field, thereby reducing training efficiency and concentration.

### SUMMARY

The present disclosure is intended to solve the problems of the prior art described above, and the present disclosure aims to create a putting environment similar to the actual golf field in the store and provide autonomous putting training content performed in the environment.

In addition, through this, the present disclosure aims to provide a system that provides systematic putting training and specialized statistics for the training, with greater training concentration and efficiency than those of training on the actual golf field.

Problems to be solved by the present disclosure are not limited to the problems mentioned above, and other problems not mentioned may be clearly understood from the description below.

As technical means for solving the above-described technical problem, an method for providing an autonomous putting training system performed by a main server, includes (a) receiving a putting autonomous training request from a user terminal, providing an autonomous training creation UI to the user terminal, and receiving a type of a training course of autonomous training to be performed and the number of steps in the training course from the user terminal by a main server; (b) generating line information connecting a hole cup and a ball, and footprint stance information about a user's position when putting is performed, matching the information with the corresponding step, and storing the information to complete the creation of autonomous training for each step, when receiving the position of the hole cup and a start position of the ball from the user terminal; (c) providing a training progress UI to the user terminal, and controlling a projector to sequentially project an image of the hole cup, the start position of the ball, and line information stored for each step on a putting field according to the corresponding step when receiving a training progress request for autonomous training of which the generation has been completed from the user terminal; and (d) analyzing a trajectory of the ball, a success rate, and a training time for each step to generate statistics information and provide a statistics UI to the terminal when the autonomous training is completed.

In addition, the autonomous training creation UI may include a training creation UI that receives a training name, a training course, and the number of steps to proceed of autonomous training according to an input of the user terminal, respectively; and a training configuration UI that receives a position of the hole cup and a start position of the ball to be set on the putting field for each of the input training course and number of steps to proceed, and the training configuration UI may further include step identification information, a plurality of step list display areas, a putting field area to set the positions of the hole cup and the ball, and a skip button for setting the next step of the corresponding step, and display an area of the putting field and a toolbar including functions of adding and deleting the hole cup to be set on one side of the putting field, and adding and deleting the start position of the ball 1 to be set.

In addition, the toolbar may set guide information to be projected for each step, and may include a point and line GUI that projects a straight line from the set start position of the ball to the target hole cup; an aim guide GUI that projects an aim direction guide for putting capable of reaching the hole cup from the set start position of the ball; a guide ball and guide line GUI that project an expected trajectory of the ball when putting is performed in a direction of the projected aim guide; a stance line GUI that projects a stance reference line to the right or left based on a user's stroke direction so that putting is performed in a preset posture; and a corridor GUI that projects an area range through which putting lines of a path capable of reaching the hole cup from the set start position of the ball pass.

In addition, in (b), the line information may refer to trajectory information that allows the ball to enter the hole cup, and include at least one of a MIN line, a MAX line, and an IDEAL line, the MIN line may be the closest trajectory to the straight line, the MAX line may be the furthest trajectory from the straight line, and the IDEAL line may be a trajectory between the MIN line and the MAX line based on the straight line from the start position of the ball to the hole cup, and the footprint stance information may refer to position information of two footprints that are ideal for putting from the start position of each ball, and be input through a center line setting menu between two footprints in the autonomous training creation UI, a stance line setting menu for connecting the centers of the two footprints, and an adjustment menu for moving the position of footprint stance information.

In addition, (c) may include transmitting images about the position of the ball and the position of the hole cup on the putting field to the local server, and receiving an optimal putting trajectory from the local server to project the optimal putting trajectory onto the putting field through a projector when the ball on the putting field is located at a preset start position of the ball, and photographing and transmitting an image of the putting field to the main server, and tracking the trajectory of the ball, and thereby an actual trajectory of the ball is displayed in real time through the projector when the ball is putted and moves from the preset start position of the ball.

In addition, (d) may include a training progress UI with which training is conducted according to training conditions received through an autonomous training creation UI, and which provides a training progress of the training through dividing of the training progress into before progress, in progress, putting success, and putting failure, and displaying those in different colors on preset sections of the putting field, and the training progress UI may divide the putting field into 12 sections with the same area and divide the 12 sections each into 3 sections so that the putting field is formed to include a total of 36 sections when the putting field is circular.

In addition, (d) may include a training result UI that provides training or step classification number, training date and time, number of putts attempted in the training, number of successful putts, number of failed putts, putting success rate, average return distance of the hit ball, and total return distances, in a table, after the training ends, provides the success rate for each breaking line depending on a preset breaking line and a pitch quality of the hit ball, in a polygonal graph, displays the training conditions for the training, and provides an average start tendency and a speed tendency over time of the balls hit during the training, in a bar-type graph, and the putting field may have a plurality of preset slopes and include breaking lines distinguished by ‘Down’ when the slope is downward, ‘Up’ when the slope is upward, and ‘Flat’ when the slope is flat.

In addition, the training result UI may provide the breaking line corresponding to the training performed in each section, the ball's direction of movement, and the ball's hitting position according to the trained putting distance in each section for hits performed in at least one of the 36 sections on the putting field, in a bar-type graph, and the hitting position of the ball may be displayed as a scale within the bar in which a point closest to the putting field is designated as ‘Low’, and a point furthest from the putting field is designated as ‘High’ based on an exact center of the ball.

In addition, when receiving a selection input for the bar-type graph according to the average speed tendency of balls hit during the training from the user terminal, the training result UI may provide the direction and the speed of the ball hit for each putting distance corresponding to the training performed in each section for hits performed in at least one of 36 sections on the putting field, and the breaking line formed by combining at least two of the 36 sections on the putting field and the pitch quality of the hit ball may be classified into at least one of ‘Straight’, ‘Hook’, and ‘Slice’, and displayed together.

In addition, the training result UI may further include a stroke result UI that provides the success or failure of the putting attempted in the training through displaying the success or failure in different color according to the section of the putting field after the training is completed, and provides a stroke time of the attempted putting in each section through displaying the stroke time in number, and the stroke time may be a time until just before the ball is hit from when the ball is recognized from the server during training and a preset training start signal is generated.

In addition, a putting autonomous training providing server according to an embodiment of the present disclosure includes a memory storing a program for performing a method for providing autonomous putting training; and a processor for executing the program, in which the method may include (a) receiving a putting autonomous training request from a user terminal, providing an autonomous training creation UI to the user terminal, and receiving a type of a training course of autonomous training to be performed and the number of steps in the training course from the user terminal by a main server; (b) generating line information connecting a hole cup and a ball, and footprint stance information about a user's position when putting is performed, matching the information with the corresponding step, and storing the information to complete the creation of autonomous training for each step, when receiving the position of the hole cup and a start position of the ball from the user terminal; (c) providing a training progress UI to the user terminal, and controlling a projector to sequentially project an image of the hole cup, the start position of the ball, and line information stored for each step on a putting field according to the corresponding step when receiving a training progress request for autonomous training of which the generation has been completed from the user terminal; and (d) analyzing a trajectory of the ball, a success rate, and a training time for each step to generate statistics information and provide a statistics UI to the terminal when the autonomous training is completed.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a structural diagram of an autonomous putting training system according to an embodiment of the present disclosure;

FIG. 2 is a block diagram illustrating an internal configuration of a main server and a local server according to an embodiment of the present disclosure;

FIG. 3 is an illustration view of an autonomous training creation UI according to an embodiment of the present disclosure;

FIG. 4 is an illustration view of a training configuration UI according to an embodiment of the present disclosure;

FIG. 5 is an illustration view of a hole cup image, a start position of a ball, and line information stored for each step, which are projected on a putting field according to an embodiment of the present disclosure;

FIG. 6 is an illustration view of a training progress UI according to an embodiment of the present disclosure;

FIG. 7 is an illustration view of a training result UI according to an embodiment of the present disclosure;

FIG. 8 an illustration view of a bar-type graph according to speed tendency according to an embodiment of the present disclosure;

FIG. 9 is an illustration view of a bar-type graph according to a speed tendency according to an embodiment of the present disclosure;

FIG. 10 is an illustration view of a stroke result UI according to an embodiment of the present disclosure; and

FIG. 11 is a flowchart of an execution order of a method for providing an autonomous putting training system according to an embodiment of the present disclosure.

### DETAILED DESCRIPTION

Below, with reference to the attached drawings, embodiments of the present disclosure will be described in detail so that those skilled in the art may easily implement the present disclosure. However, the present disclosure may be implemented in many different forms and is not limited to the embodiments described herein. In order to clearly explain the present disclosure in the drawings, parts that are not related to the description are omitted, and similar parts are given similar reference numerals throughout the specification.

Throughout the specification, when a part is said to be “connected” to another part, this includes not only the case where it is “directly connected,” but also the case where it is “electrically connected” with another element therebetween. Additionally, when a part “includes” a certain component, this means that it may further include other components rather than excluding other components, unless specifically stated to the contrary.

In this specification, ‘portion’ includes a unit realized by hardware, a unit realized by software, and a unit realized using both. Additionally, one unit may be realized using two or more pieces of hardware, and two or more units may be realized using one piece of hardware. Meanwhile, ‘˜ portion’ is not limited to software or hardware, and ‘˜ portion’ may be configured to reside in an addressable storage medium or may be configured to reproduce one or more processors. Therefore, as an example, ‘˜ portion’ includes components such as software components, object-oriented software components, class components, and task components, processes, functions, properties, procedures, subroutines, segments of program code, drivers, firmware, microcode, circuits, data, databases, data structures, tables, arrays, and variables. The functions provided within the components and ‘portions’ may be combined into a smaller number of components and ‘portions’ or may be further separated into additional components and ‘portions’. Additionally, components and ‘portions’ may be implemented to regenerate one or more CPUs within a device or a secure multimedia card.

The “terminal” mentioned below may be implemented as a computer or portable terminal that may connect to a server or other terminal through a network. Here, the computer includes, for example, a laptop equipped with a web browser, a desktop, a laptop, a VR HMD (e.g., HTC VIVE, Oculus Rift, GearVR, DayDream, PSVR, etc.), etc. Here, VR HMD includes all for PC (e.g., HTC VIVE, Oculus Rift, FOVE, Deepon, etc.), mobile (e.g., GearVR, DayDream, Storm Magic, Google Cardboard, etc.), console (PSVR), and independently implemented Stand Alone models (e.g., Deepon, PICO, etc.). Portable terminals is, for example, wireless communication devices that ensure portability and mobility, and may include smart phones, tablet PCs, and wearable devices, as well as various devices equipped with communication modules such as Bluetooth (BLE, Bluetooth Low Energy), NFC, RFID, ultrasonic, infrared, WiFi, and LiFi. In addition, “network” refers to a connection structure that allows information exchange between nodes such as terminals and servers, and includes a local area network (LAN), a wide area network (WAN), and the Internet (WWW: World Wide Web), wired and wireless data communication network, telephone network, wired and wireless television communication network, etc. Examples of wireless data communication networks include 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasound communication, Visible Light Communication (VLC), LiFi, etc., but is not limited thereto.

The present disclosure relates to an autonomous putting training system and a method therefor, and relates to a technology that analyzes user's putting on the putting field between autonomous training content performed in an environment similar to an actual golf green and the performance of the training content, provides the most ideal path and statistics for the ball 1 of the putting to reach the hole cup, and putts to such an ideal path.

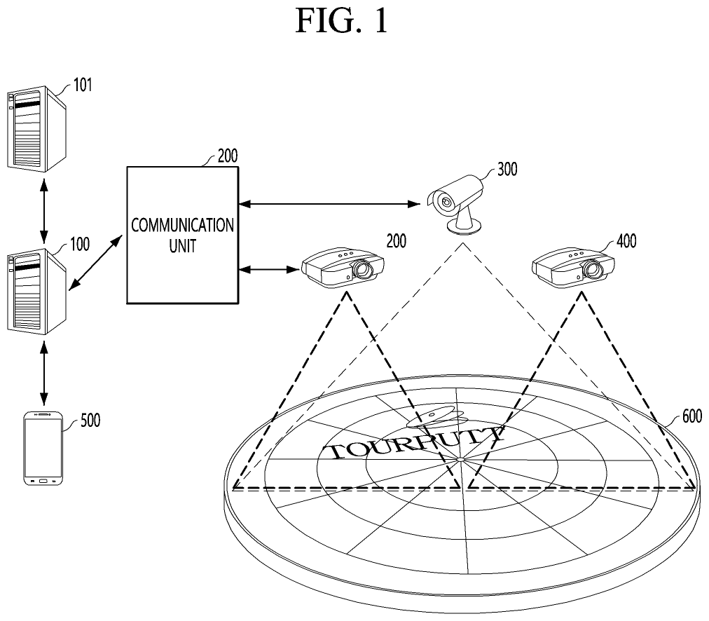

With reference to FIG. 1, for this purpose, the autonomous putting training system according to an embodiment of the present disclosure may be configured to include a main server 100, a local server 101, a store terminal 200, at least one camera device 300, a plurality of projectors 400, a user terminal 500, and a putting field 600.

The main server 100 and the local server 101 according to an embodiment of the present disclosure may be configured to include a memory storing a program (or application) for performing a method for providing an autonomous putting training system, a processor executing the above program, and a database (DB). Here, the processor may perform various functions depending on the execution of the program stored in the memory, and the functions performed by the main server 100 and the local server 101 will be described in detail later.

The store terminal 200 may be implemented in various forms according to various embodiments, but in a preferred embodiment, it includes a touch panel or a controller that may be operated by a user, and a program or an application, which may be connected and communicated wired and wirelessly to the main server 100, the local server 101, the camera device 300, and the user terminal 500, and may display a predetermined UI (User Interface) received from the main server 100 or the local server 101 on a screen, may be installed.

The store terminals 200 may be implemented in either a form in which the store terminals 200 are fixed and installed together in a space where the system of the present disclosure is installed or a form in which the store terminals 200 are connected via wireless communication and carried by the user, and a representative example may be in a form of a tablet PC.

The store terminals 200 implemented as described above are installed in a plurality of stores and collect data about a putting field 600 with the camera device 300, and serve to provide the collected data to a main server 100, and according to another embodiment of the present disclosure, the previously described programs and applications may be installed on the user terminal 500 to perform the role of the store terminal 200.

In this case, the camera device 300 may also be replaced with a built-in camera module of the user terminal 500, and the user may directly take pictures with the built-in camera module after executing the corresponding program or application.

Next, the projector 400 may project at least one putting trajectory onto the putting field under the control of the main server 100, and may be installed in a predetermined space above a place where the system of the present disclosure is installed (hereinafter referred to as putting room), for example, a plurality of the projectors 400 may be installed on the ceiling, etc. to project the putting trajectory.

According to a further embodiment of the present disclosure, the plurality of projectors 400 are set to project different images (e.g., different UIs) when at least two projectors 400 are installed, so that the plurality of projectors 400 project simultaneously. As a result, overlapping projection images may be projected to include multiple pieces of information or interfaces.

In addition, the putting field 600 according to an embodiment of the present disclosure is installed in a plurality of stores, refers to a predetermined space where putting for a ball 1 is performed, and is installed on a floor of the putting room. A surface on which putting is performed may be formed of artificial turf or natural turf.

Here, the putting field 600 has a plurality of preset slopes, and may include breaking lines distinguished by ‘Down’ when the slope is downward in a direction in which the ball 1 travels based on the ball 1, ‘Up’ when the slope is upward, and ‘Flat’ when the slope is flat when putting is performed. The breaking lines will be described along with an explanation of the operations of the main server 100 and the local server 101, which will be described later.

Hereinafter, the execution of the method for providing an autonomous putting training system performed by the main server 100 will be described based on the optimal putting path providing system described above.

First, the main server 100 receives an autonomous putting training request from the user terminal 500, provides the autonomous training creation UI to the user terminal 500, and receives a type a training course of autonomous putting training to be performed and number of steps in the training course from the user terminal 500.

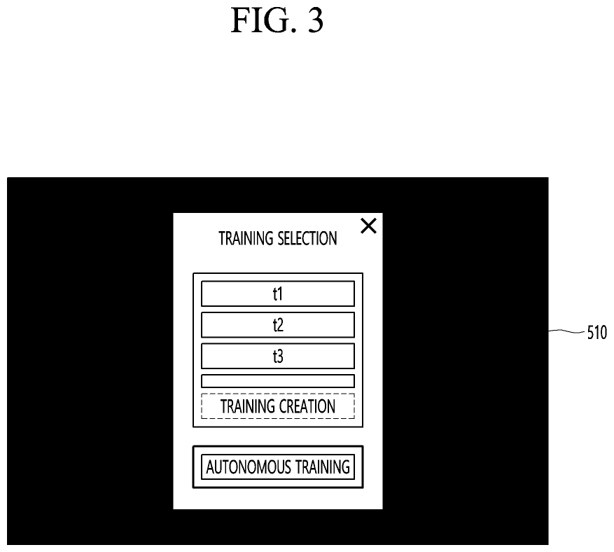

Referring to FIG. 3, according to an embodiment of the present disclosure, the main server 100 may receive the autonomous putting training request through the autonomous training creation UI, and the autonomous training creation UI may provide a plurality of preset buttons, in addition to the autonomous training button that transmits the autonomous putting training request to the main server 100, to provide autonomous putting training with pre-stored training settings.

In addition, the autonomous training creation UI may include a training creation UI 510 that receives the training name, training course, and number of steps to proceed of autonomous training according to the input of the user terminal 500, respectively, and a training configuration UI 520 that receives the position of the hole cup 2 and the start position of the ball 1 to be set on the putting field 600 for each of the input training course and number of steps to proceed.

When the autonomous training button is selected and input by the user terminal 500, the main server 100 may provide the training configuration UI 520 to the user terminal 500.

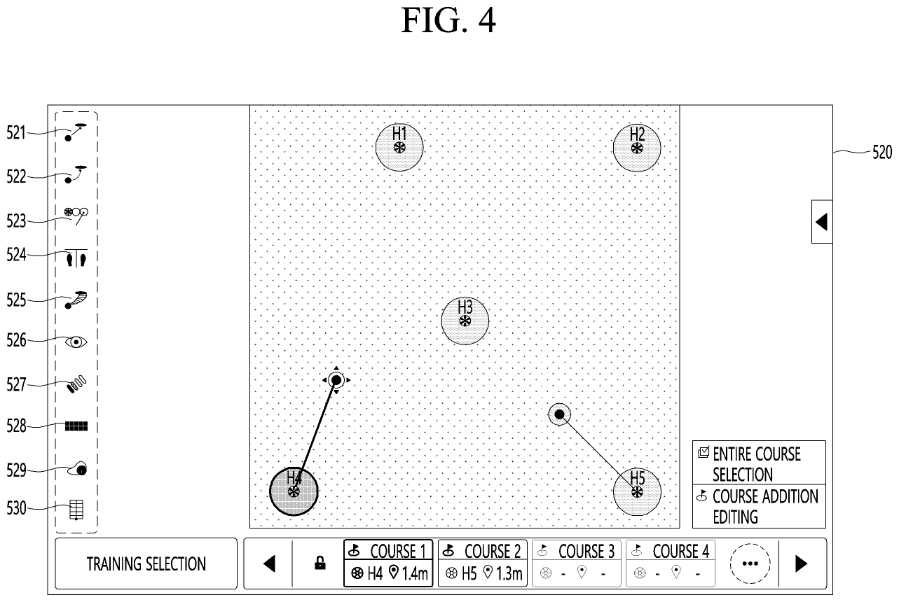

Referring to FIG. 4, the training configuration UI 520 according to an embodiment of the present disclosure may further include step identification information, a plurality of step list display areas, a putting field 600 area to set the positions of the hole cup 2 and the ball, and a skip button for setting the next step of the corresponding step, and may display one area of the putting field 600.

At this time, the putting field 600 may be displayed in different forms according to various embodiments, but to facilitate understanding, the description will be made assuming an embodiment in which the putting field 600 is displayed in a square shape. The main server 100 may also display a toolbar including functions of adding and deleting the hole cup 2 to be set on one side of the displayed square-shaped putting field 600, and adding and deleting the start position of the ball 1 to be set.

Here, the toolbar is composed of a plurality of graphic user interfaces (GUIs), and each GUI may provide different functions as being selected and input by the user terminal 500.

The toolbar according to an embodiment of the present disclosure may include a point and line GUI 521 that projects a straight line from the set start position of the ball 1 to the target hole cup 2, an aim guide GUI 523 that projects an aim direction guide for putting capable of reaching the hole cup 2 from the set start position of the ball 1, a guide ball and guide line GUI 522 that project an expected trajectory of the ball 1 when putting is performed in the direction of the projected aim guide, a stance line GUI 524 that projects a stance reference line to the right or left based on the user's stroke direction so that putting is performed in a preset posture, and a corridor GUI 525 that projects an area range through which the putting lines of the path capable of reaching the hole cup 2 from the set start position of the ball 1 pass.

In addition, according to an additional embodiment of the present disclosure, the toolbar may further include a visual cueing GUI 526 that projects multifaceted cueing elements related to putting line image training during training such as a friction force of the putting field 600 when putting is performed on the provided path, a straight-line distance between the ball 1 and the hole cup 2, and a temperature and humidity of the space where putting is performed onto one area of the putting field 600, a rhythm GUI 527 that is provided in a form of a xylophone so that the user is able to train a stroke rhythm and projects a tempo guide that lights up in different colors according to a preset rhythm, The Arc GUI 528 that initially recognizes the movement of the face of the putter (golf club) and projects a putter shape moving for training, a reading guide GUI 529 that provides green information such as direction, distance, height difference, and aim direction required to successfully putt, and a putting line GUI 530 that projects a grid within the area where putting is able to be entered and projects a grid slope, the set slope direction, etc.

The user may designate each step through the training configuration UI 520 and set the positions of the hole cup 2 and the ball for each step for a plurality of steps.

Here, the step refers to the number of putts performed per unit training. Hereinafter, the description will be made assuming that one putting performed during one training session is the step.

The user may add and delete a plurality of hole cups 2 on one side or at an arbitrary location of the displayed putting field GUI in the putting field GUI displaying one area of the putting field 600 on the user terminal 500, and may also add and delete the start position of the ball 1. At this time, the position of the hole cup 2 and the start position of the ball 1 may be determined using a drag and drop method.

When receiving the position of the hole cup 2 and the start position of the ball 1 from the user terminal 500, the main server 100 generates information on a line connecting the hole cup 2 and the start position of the ball 1, and information on footprint stance about the user's position when putting is performed, and completes the creation of autonomous training through matching the information with the corresponding step and storing the information.

At this time, line information refers to trajectory information that allows the ball 1 to enter the hole cup 2, and includes at least one of a MIN line, a MAX line, and an IDEAL line, and the MIN line may be the closest trajectory to the straight line, the MAX line may be the furthest trajectory from the straight line, and the IDEAL line may be the trajectory between the MIN line and the MAX line based on the straight line from the start position of the ball 1 to the hole cup 2.

In addition, footprint stance information refers to position information of two footprints that are ideal for putting from the start position of each ball 1, and may be input through a center line setting menu between two footprints in the autonomous training creation UI, a stance line setting menu for connecting the centers of the two footprints, and an adjustment menu for moving the position of footprint stance information.

In order to generate the line information and footprint stance information described above, the main server 100 may generate the trajectory for the ball 1 to enter (hole-in) the hole cup 2 from the start position of the ball 1 to the hole cup 2.

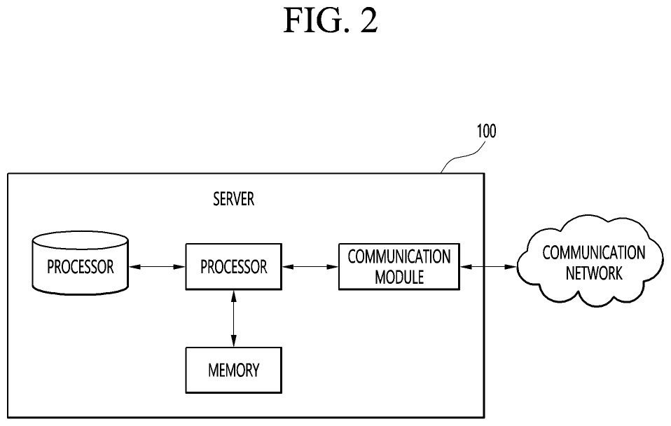

In addition to the configuration described above in FIG. 2, the main server 100 and the local server 101 include a memory storing a program (or application) for performing the putting optimal path providing method, a processor executing the program, and a database (DB), and the camera device 300 collects data about the putting field 600 and provides the collected data to the main server 100.

By means of the configuration described above, the main server 100 collects data about the putting field 600 according to the execution of the processor, and performs a simulation of the putting performed at a plurality of positions within the installed putting field 600.

Here, the simulation may be performed in a way of calculating a plurality of trajectory data by calculating the trajectory of the ball 1 by considering a friction force and the slope of the putting field 600 when the ball 1 is hit in all possible hitting directions to be executed without specifying a direction of the putter (head portion of the golf club) at a plurality of preset putting start positions.

In addition, when the user hits the ball 1 in one direction, the simulation calculates the entire trajectory of the hit ball 1 in a case where the user hits the ball 1 with all the hitting forces that may be performed at a specific hitting force interval from the minimum value to the maximum value of a preset hitting force. It may be simulated by considering parameters of the putting field 600 including a height, a breaking line, a slope, and a friction force for each section of a terrain that constitutes the putting field 600 pre-stored in the main server 100. Therefore, simulations may be performed for various hits having result values, with which the ball 1 reaches the hole cup 2, and through this, the main server 100 of the present disclosure may obtain a hitting trajectory that reflects various indicators such as terrain section, height, and friction force, rather than necessarily a linear hitting trajectory between the ball 1 and the hole cup 2.

Next, the main server 100 selects the trajectory data of the ball 1 entering the hole cup 2 among the trajectory data for the plurality of balls 1 derived from the simulation results, and selects the optimal putting trajectory 555 from the selected trajectory data.

In general, in situations where realistic physical laws exist, there are countless cases in which the ball 1 may simply enter the hole cup 2. Among these cases, in order to select the optimal putting trajectory, the main server 100 considers the time taken for the hit ball 1 to reach the hole cup 2, the distance for the hit ball 1 to reach the hole cup 2, and the curvature of the trajectory of the hit ball 1 until it reaches the hole cup 2 among the plurality of trajectory data to select a hitting trajectory, in which at least one of the reaching time, the reaching distance, and the curvature thereof is the minimum value, as the optimal putting trajectory 555.

According to another embodiment of the present disclosure, when selecting the optimal putting trajectory 555, the main server 100 may also select trajectory data located in the middle in the order (for example, trajectory data corresponding to the 15th number of cases among a plurality of trajectory data corresponding to the number of 30 cases) as the optimal putting trajectory 555 among the plurality of trajectory data corresponding to data between the result value with the minimum value and the result value with the maximum value of the slope of the putting field 600 in the direction from the position of the ball 1 to the hole cup 2, among the result values of the performed simulation data.

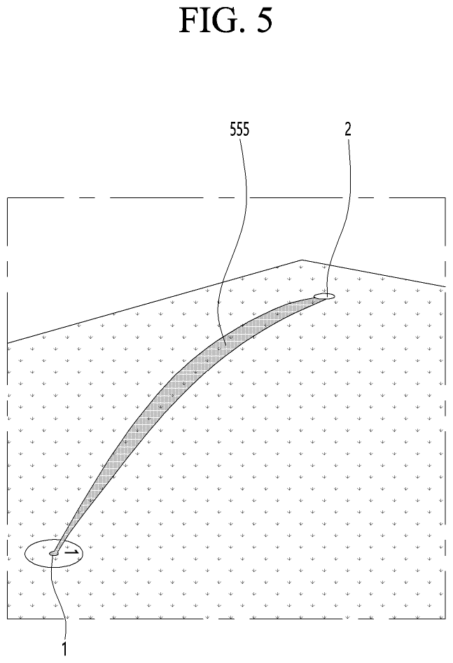

With reference to FIG. 5, the optimal putting trajectory 555 selected in this way is matched with the putting start position of the ball 1, the main server 100 transmits the optimal putting trajectory 555 to at least one local server 101, the optimal putting trajectory 555 received by the local server 101 is stored, and the optimal putting trajectory 555 may be used in a trajectory provision process which will be described later.

Meanwhile, when receiving the training progress request for autonomous training of which the generation has been completed from the user terminal 500, the main server 100 may provide the training progress UI 540 on the user terminal 500 and control the projector 400 to sequentially project the image of the hole cup 2, the start position of the ball 1, and line information stored for each step, on the putting field 600 according to the corresponding step.

When the ball 1 on the putting field 600 is located at the start position of the ball 1 set through the previous training configuration UI 520, the main server 100 transmits images about the position of the ball 1 and the position of the hole cup 2 on the putting field 600 to the local server 101, and receives the optimal putting trajectory 555 from the local server 101 to project the optimal putting trajectory 555 onto the putting field 600 through the projector 400.

In addition, when the ball 1 is putted and moves from the preset start position of the ball 1, the image of the putting field 600 is photographed and transmitted to the main server 100, and the main server 100 tracks the trajectory of the ball 1, and thereby the actual trajectory of the ball 1 may be displayed in real time through the projector 400.

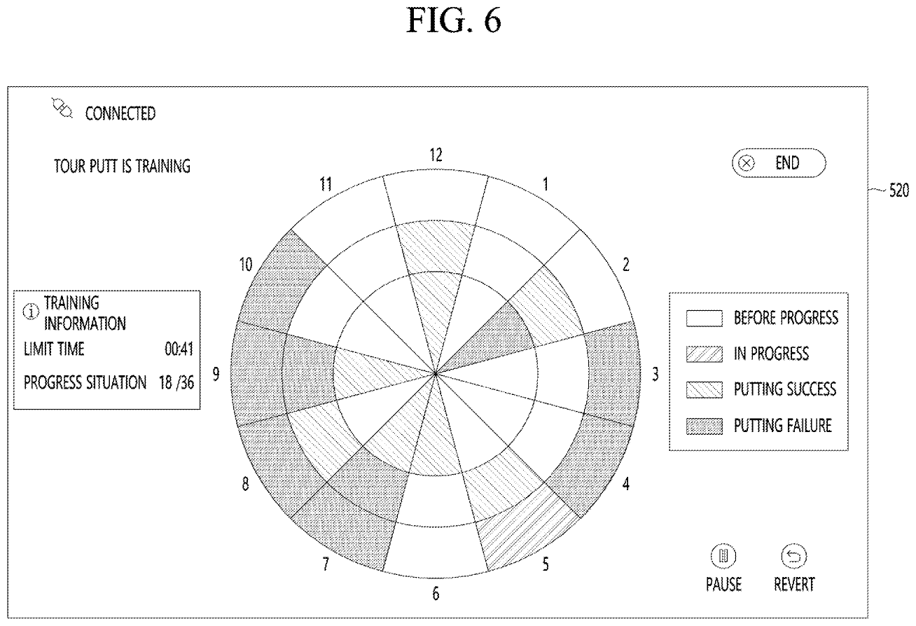

At this time, with reference to FIG. 6, when the putting field 600 is circular, the training progress UI 540 divides the putting field 600 into 12 sections with the same area, and divides the 12 sections each into 3 sections so that it may be formed to include a total of 36 sections.

In the 36 divided sections, at least one putting may be performed for each section, and the results and progress of putting performed in each section may be displayed in distinct colors by being divided into a state where putting is currently in progress (state where the user and the ball 1 are located at the designated training positions, but putting has not yet been performed), a state where putting has been performed but the hit ball 1 has not entered the hole cup 2, and a state where putting has been performed and the hit ball 1 has entered the hole cup 2.

Among these, in a state where putting is currently in progress, in the training progress UI 540, along with the GUI (Graphic User Interface) of the putting field 600, there is a GUI, which illustrates the time limit for the putting being currently performed and which putt the current putting is among a total of 36 putts, may be displayed together.

When at least one putting is performed for each section and a total of 36 putts may be performed, the local server 101 determine that the training is completed, collect the trajectory and hitting results of the ball 1 hit by the user, and visualizes the statistics thereof to be provided.

When autonomous training is completed, the above-described statistics are generated as statistics information by analyzing the trajectory, success rate, and training time of the ball 1 for each step, and may be provided to the user terminal 500 through the statistics UI.

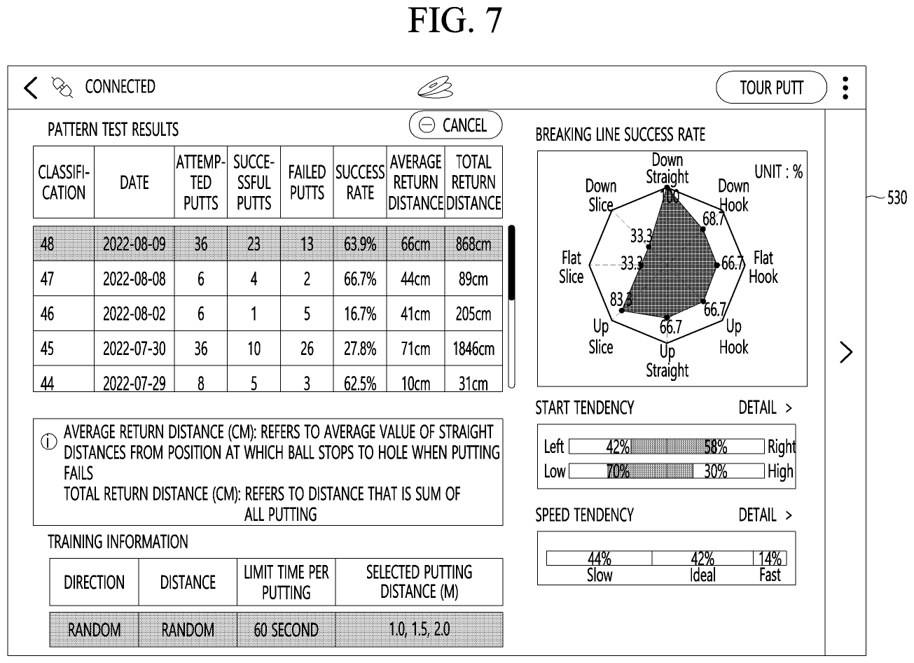

As illustrated in FIG. 7, the training result UI 550 according to an embodiment of the present disclosure may provide training classification number, training date and time, number of putts attempted in the training, number of successful putts, number of failed putts, putting success rate, average return distance of the hit ball, and total return distances, in a table, provide the success rate for each breaking line depending on a preset breaking line and the pitch quality of the hit ball 1, in a polygonal graph, display the training conditions for the training, and provide the average start tendency and speed tendency over time of balls 1 hit during the training, in a bar-type graph, after the training ends.

Each of indicators for the training provided as described above may be provided on one screen or on each independent screen through an independent sheet or GUI, and detailed information may be provided when receiving a selection input from the user terminal 500.

For example, when receiving a selection input for a bar-type graph according to the average speed tendency of balls 1 hit during the training from the user terminal 500, for hits performed in at least one of 36 sections on the putting field 600, the direction and speed of the ball 1 hit for each putting distance corresponding to the training performed in each section may be provided in a table.

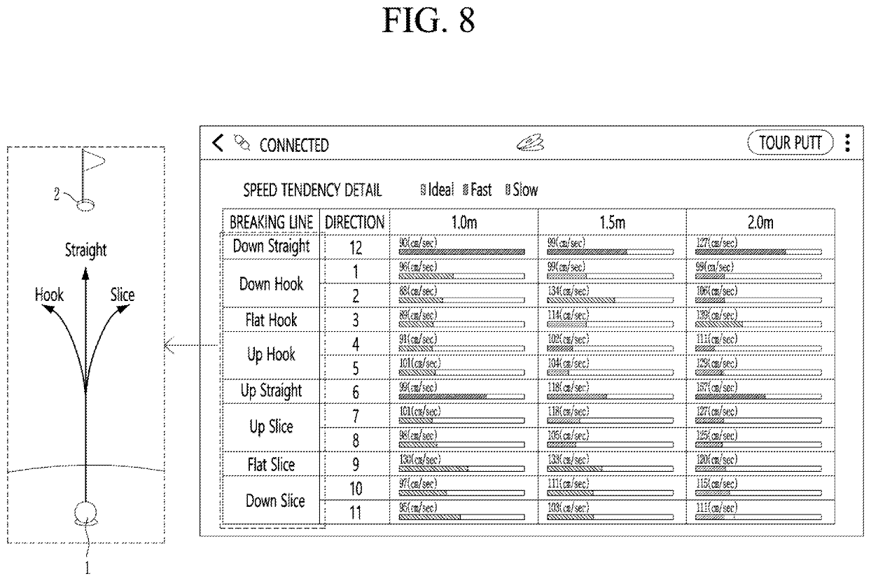

At this time, with reference to FIG. 8, the pitch quality of the ball 1 hit in each putting may be provided separately by breaking line. The pitch quality of the hit ball 1 is divided into ‘Straight’ in a case where the ball 1 goes straight without bending as illustrated, ‘Hook’ in a case where the ball 1 bends to the inside of the user's body, that is, inward, and ‘Slice’ in a case where the ball 1 bends to the outside of the user's body, that is, outward.

In addition, the breaking line of the putting field 600 corresponding to the path of the hit ball 1 may be provided by being divided into ‘Down’ in a case where the slope is downhill, ‘Up’ in a case where the slope is uphill, and ‘Flat’ in a case where the slope is flat.

Therefore, the user may determine how the pitch quality of the ball 1 he or she has hit is affected by the terrain. Through this, if a different pitch quality occurs on the same terrain, the user may quickly identify the problem of the hit, thereby making it useful for putting training.

Similarly, in a case where a selection input for the bar-type graph 551 according to the average start tendency of balls 1 hit during the training is received from the user terminal 500, for hits performed in at least one of the 36 sections on the putting field 600, the breaking line corresponding to the training performed in each section, the direction of movement of the ball 1, and the hitting position of the ball 1 according to the trained putting distance may be provided in a bar-type graph.

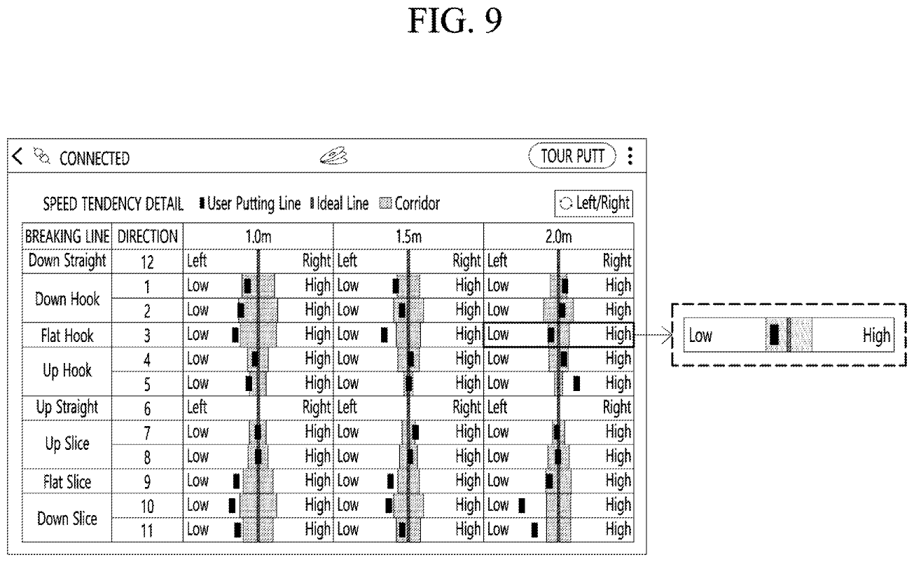

As illustrated in FIG. 9, the graph according to the start tendency, like the graph according to the speed tendency, also displays the pitch quality and breaking line of the hit ball 1 together, and in a case of the hitting position of the ball 1, the start direction of the ball 1 where the putting is performed may be displayed as a scale within the bar in which a side with a low slope of the terrain is designated as ‘Low’, and a side with a high slope is designated as ‘High’ based on a straight line between the ball 1 and the target hole cup 2.

Meanwhile, according to another embodiment of the present disclosure, in addition to Low and High for the hitting position of the ball 1, the UI may display the left direction of the user performing the putting as ‘Left’ and the right direction as ‘Right’, as a scale in the bar.

Through this, when performing the hit, the user may check whether the ball went left, right, or on the high or low side of the ground slope which are compared therebetween based on a line perpendicular to the start direction corresponding to the ideal putting trajectory of the angle of the face surface of the club when the hitting is performed. Therefore, the check may be useful for performing putting training by considering the pitch quality and the breaking line of the ball 1 that occur accordingly.

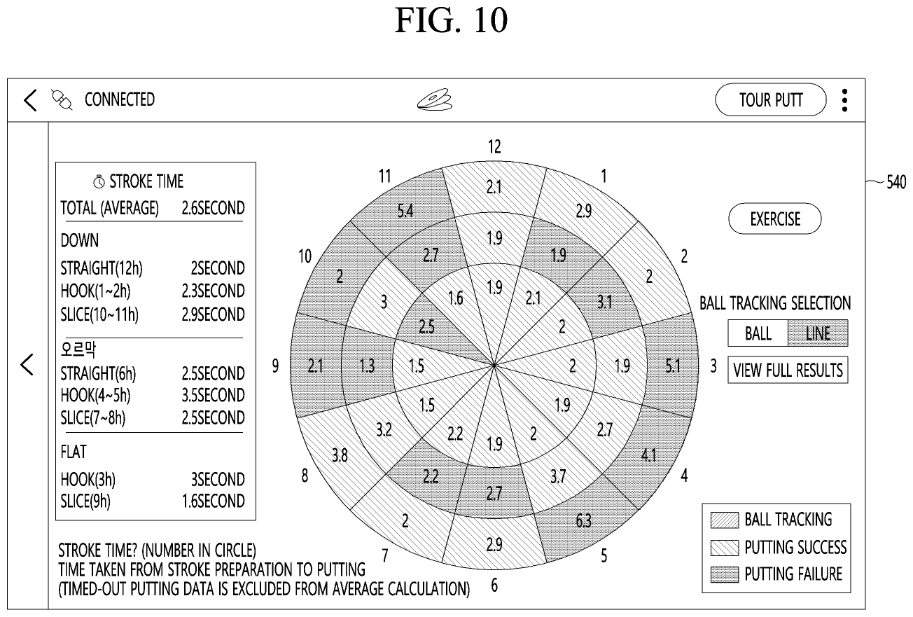

In addition, with reference to FIG. 10, the training result UI 550 may further include a stroke result UI 560 that provides the success or failure of the putting attempted in the training through displaying it in different color according to the section of the putting field 600 after the training is completed, and provides a stroke time of the attempted putting in each section through displaying it in number.

At this time, the stroke time meant in the present disclosure is the time until just before the ball 1 is hit from when the ball 1 is recognized from the main server 100 or local server 101 during training and a preset training start signal is generated, and refers to an indicator that may be checked to see how consistent the putting routine is by checking he time taken for the user to perform putting.

The stroke result UI 560 may be implemented in different forms according to various embodiments, but in the preferred embodiment, a putting field GUI is included that displays the success or failure of the attempted putting in different colors according to the section of the putting field 600. The stroke time may be displayed together on the putting field GUI, and the stroke time for all putting performed during training may be displayed together by being divided by breaking line and the pitch quality.

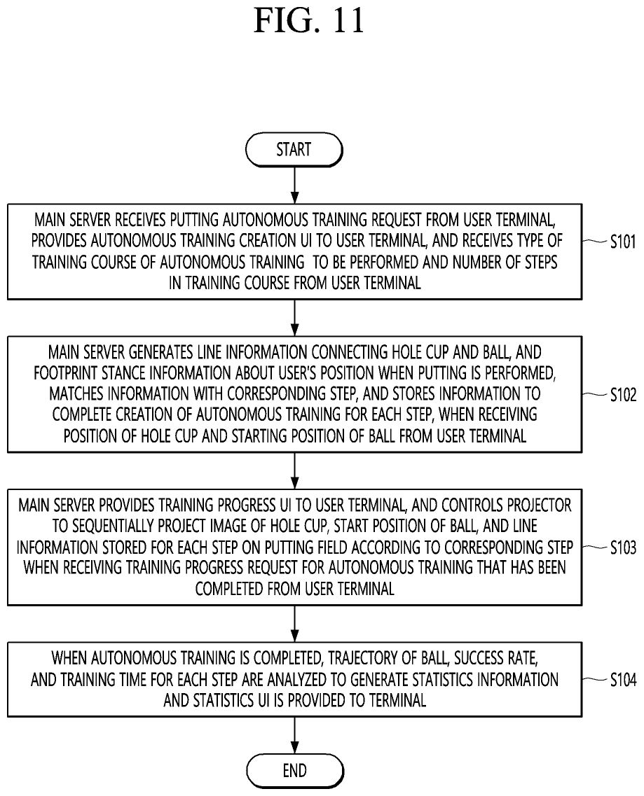

Below, with reference to FIG. 11, the execution order of the method for providing an optimal putting path according to an embodiment of the present disclosure will be described.

The main server 100 receives the putting autonomous training request from the user terminal 500, provides the autonomous training creation UI to the user terminal 500, and receives a type of a training course of autonomous training to be performed and the number of steps in the training course from the user terminal 500 (S101).

The main server 100 generates line information connecting the hole cup 2 and the ball 1, and footprint stance information about the user's position when putting is performed, matches the information with the corresponding step, and stores the information to complete the creation of autonomous training for each step, when receiving the position of the hole cup 2 and the start position of the ball 1 from the user terminal 500 (S102).

Next, the main server 100 provides the training progress UI 540 to the user terminal 500, and controls the projector 400 to sequentially project the image of the hole cup 2, the start position of the ball 1, and line information stored for each step on the putting field 600 according to the corresponding step when receiving a training progress request for autonomous training that has been completed from the user terminal 500 (S103).

Afterwards, when the autonomous training is completed, the trajectory of the ball 1, success rate, and training time for each step are analyzed to generate statistics information and the statistics UI is provided to the terminal (S104).

The present disclosure provides a putting autonomous training system so that it is possible to perform putting training in an environment similar to an actual golf field, provide various putting autonomous training contents that may be set arbitrarily by the user, and provide specialized statistics on the performed putting training and analysis data based on this.

Through this, the present disclosure may provide a putting training service of superior quality than putting training performed in an actual golf field.

An embodiment of the present disclosure may also be implemented in a form of a recording medium containing instructions executable by a computer, such as program modules executed by a computer. Computer-readable media may be any available media that may be accessed by a computer and may include all of volatile and non-volatile media, removable and non-removable media. In addition, computer-readable media may include all computer storage media. Computer storage media includes all volatile and non-volatile, removable and non-removable media implemented in any method or technology for storage of information such as computer-readable instructions, data structures, program modules, or other data.

Although the methods and systems of the present disclosure have been described with respect to specific embodiments, some or all of their components or operations may be implemented using a computer system having a general-purpose hardware architecture.

The description of the present disclosure described above is for illustrative purposes, and those skilled in the art will understand that the present disclosure may be easily modified into other specific forms without changing the technical idea or essential features of the present disclosure. Therefore, the embodiments described above should be understood in all respects as illustrative and not restrictive. For example, each component described as a single type may be implemented in a distributed manner, and similarly, components described as distributed manner may also be implemented in a combined form.

The scope of the present disclosure is indicated by the claims described below rather than the detailed description above, and all changes or modified forms derived from the meaning and scope of the claims and their equivalent concepts should be construed as being included in the scope of the present disclosure.

What is claimed is:

1. A method for providing an autonomous putting training system performed by a main server, comprising:
(a) Receiving a putting autonomous training request from a user terminal, providing an autonomous training creation UI to the user terminal, and receiving a type of a training course of autonomous training to be performed and a number of steps in the training course from the user terminal by a main server;
(b) Generating line information connecting a hole cup and a ball, and footprint stance information about a user's position when putting is performed, matching the information with the corresponding step, and storing the information to complete the creation of autonomous training for each step, when receiving the position of the hole cup and a start position of the ball from the user terminal;
(c) Providing a training progress UI to the user terminal, and controlling a projector to sequentially project an image of the hole cup, the start position of the ball, and line information stored for each step on a putting field according to the corresponding step when receiving a training progress request for autonomous training of which the generation has been completed from the user terminal; and
(d) Analyzing a trajectory of the ball, a success rate, and a training time for each step to generate statistics information and provide a statistics UI to the terminal when the autonomous training is completed.

2. The method for providing an autonomous putting training system of claim 1, wherein the autonomous training creation UI includes:
a training creation UI that receives a training name, a training course, and the number of steps to proceed of autonomous training according to an input of the user terminal, respectively; and
a training configuration UI that receives a position of the hole cup and a start position of the ball to be set on the putting field for each of the input training course and number of steps to proceed, and
the training configuration UI further includes step identification information, a plurality of step list display areas, a putting field area to set the positions of the hole cup and the ball, and a skip button for setting a next step of the corresponding step, and displays an area of the putting field and a toolbar including functions of adding and deleting the hole cup to be set on one side of the putting field, and adding and deleting the start position of the ball to be set.

3. The method for providing an autonomous putting training system of claim 2, wherein the toolbar sets guide information to be projected for each step, and includes:
a point and line GUI that projects a straight line from the set start position of the ball to the hole cup;
an aim guide GUI that projects an aim direction guide for putting capable of reaching the hole cup from the set start position of the ball;
a guide ball and guide line GUI that project an expected trajectory of the ball when putting is performed in a direction of the projected aim guide;
a stance line GUI that projects a stance reference line to right or left based on a user's stroke direction so that putting is performed in a preset posture; and
a corridor GUI that projects an area range through which putting lines of a path capable of reaching the hole cup from the set start position of the ball pass.

4. The method for providing an autonomous putting training system of claim 1, wherein, in (b),
the line information refers to trajectory information that allows the ball to enter the hole cup, and includes at least one of a MIN line, a MAX line, and an IDEAL line,
the MIN line is the closest trajectory to a straight line, the MAX line is the furthest trajectory from the straight line, and the IDEAL line is a trajectory between the MIN line and the MAX line based on the straight line from the start position of the ball to the hole cup, and
the footprint stance information refers to position information of two footprints that are ideal for putting from the start position of each ball, and is input through a center line setting menu between two footprints in the autonomous training creation UI, a stance line setting menu for connecting the centers of the two footprints, and an adjustment menu for moving the position of footprint stance information.

5. The method for providing an autonomous putting training system of claim 1, wherein (c) includes:
transmitting images about the position of the ball and the position of the hole cup on the putting field to a local server, and receiving an optimal putting trajectory from the local server to project the optimal putting trajectory onto the putting field through a projector when the ball on the putting field is located at a preset start position of the ball; and
photographing and transmitting an image of the putting field to the main server, and tracking the trajectory of the ball, and thereby an actual trajectory of the ball is displayed in real time through the projector when the ball is putted and moves from the preset start position of the ball.

6. The method for providing an autonomous putting training system of claim 1, wherein
(d) includes a training progress UI with which training is conducted according to training conditions received through an autonomous training creation UI, and which provides a training progress of the training through dividing of the training progress into before progress, in progress, putting success, and putting failure, and displaying those in different colors on preset sections of the putting field, and
the training progress UI divides the putting field into 12 sections with the same area and divides the 12 sections each into 3 sections so that the putting field is formed to include a total of 36 sections when the putting field is circular.

7. The method for providing an autonomous putting training system of claim 6, wherein
(d) includes a training result UI that provides training or step classification number, training date and time, number of putts attempted in the training, number of successful putts, number of failed putts, putting success rate, average return distance of the hit ball, and total return distances, in a table, after the training ends, provides the success rate for each breaking line depending on a preset breaking line and a pitch quality of the hit ball, in a polygonal graph, displays the training conditions for the training, and provides an average start tendency and a speed tendency over time of the balls hit during the training, in a bar-type graph, and
the putting field has a plurality of preset slopes and includes breaking lines distinguished by ‘Down’ when the slope is downward, ‘Up’ when the slope is upward, and ‘Flat’ when the slope is flat.

8. The method for providing an autonomous putting training system of claim 7, wherein
the training result UI provides the breaking line corresponding to the training performed in each section, the ball's direction of movement, and the ball's hitting position according to the trained putting distance in each section for hits performed in at least one of the 36 sections on the putting field, in a bar-type graph, and
the hitting position of the ball is displayed as a scale within the bar in which a point closest to the putting field is designated as ‘Low’, and a point furthest from the putting field is designated as ‘High’ based on an exact center of the ball.

9. The method for providing an autonomous putting training system of claim 7, wherein
when receiving a selection input for the bar-type graph according to the average speed tendency of balls hit during the training from the user terminal, the training result UI provides a direction and the speed of the ball hit for each putting distance corresponding to the training performed in each section for hits performed in at least one of 36 sections on the putting field, and
the breaking line formed by combining at least two of the 36 sections on the putting field and the pitch quality of the hit ball are classified into at least one of ‘Straight’, ‘Hook’, and ‘Slice’, and displayed together.

10. The method for providing an autonomous putting training system of claim 7, wherein
the training result UI further includes a stroke result UI that provides success or failure of the putting attempted in the training through displaying the success or failure in different color according to the section of the putting field after the training is completed, and provides a stroke time of the attempted putting in each section through displaying the stroke time in number, and
the stroke time is a time until just before the ball is hit from when the ball is recognized from the server during training and a preset training start signal is generated.

11. A putting autonomous training providing server comprising:
a memory storing a program for performing a method for providing autonomous putting training; and
a processor for executing the program,
wherein the method includes:
(a) receiving a putting autonomous training request from a user terminal, providing an autonomous training creation UI to the user terminal, and receiving a type of a training course of autonomous training to be performed and a number of steps in the training course from the user terminal by a main server;
(b) generating line information connecting a hole cup and a ball, and footprint stance information about a user's position when putting is performed, matching the information with the corresponding step, and storing the information to complete the creation of autonomous training for each step, when receiving the position of the hole cup and a start position of the ball from the user terminal;
(c) providing a training progress UI to the user terminal, and controlling a projector to sequentially project an image of the hole cup, the start position of the ball, and line information stored for each step on a putting field according to the corresponding step when receiving a training progress request for autonomous training of which the generation has been completed from the user terminal; and
(d) analyzing a trajectory of the ball, a success rate, and a training time for each step to generate statistics information and provide a statistics UI to the terminal when the autonomous training is completed.
